(19) United States
(12) Patent Application Publication
(10) Pub. No.: US 2015/0039525 A1
(43) Pub. Date: Feb. 5, 2015

(54) SELECTIVE COMMUNICATION OF JOB OPENINGS TO POTENTIAL REFERRERS

(71) Applicant: JobLark, Inc., Salt Lake City, UT (US)

(72) Inventors: Scott White Frazier, Alpine, UT (US); Eric Joel Shelley, West Jordan, UT (US); Zachary Matthew Richardson, Orem, UT (US); Kendall Scott Frazier, Salt Lake City, UT (US)

(21) Appl. No.: 14/373,867

(22) PCT Filed: Feb. 22, 2013
(86) PCT No.: PCT/US13/27506

§ 371 Date: Jul. 22, 2014

Related U.S. Application Data
(60) Provisional application No. 61/602,338, filed on Feb. 23, 2012.

(51) Int. Cl. G06Q 50/00; H04L 29/06; G06Q 10/10; G06F 17/30

(52) U.S. Cl. CPC G06Q 50/01; G06F 17/30598; H04L 63/083; G06F 17/30867; G06Q 10/105
USPC 705/319

(57) ABSTRACT

Embodiments are directed to constructing an employee referral network, selectively communicating job opportunities to potential job referrers and to facilitating incognito job referrals. In one scenario, a computer system imports professional contacts for an employee from at least one source of professional contacts. The computer system categorizes the imported professional contacts according to criteria provided by the employee's employer, then further constructs an employee referral network that includes the employee's professional contacts that have met the criteria provided by the employee's employer and selectively communicates the job opportunities through the constructed employee referral network to those professional contacts who meet the employer's criteria.

### CROSS-REFERENCE TO RELATED APPLICATIONS

This application claims priority to, and the benefit of, U.S. Provisional Application Ser. No. 61/602,338, filed on Feb. 23, 2012, entitled “Selective Communication of Job Openings to Potential Referrers,” which application is incorporated by reference herein in its entirety.

### BACKGROUND

In the past, job openings were typically spread by newspaper, company job postings and word of mouth. Today, social media networks are increasingly used in obtaining and disseminating job referrals. Human resources (HR) managers often look to social media networks to determine people's skills and work experience. Different social media networks including Facebook™ and LinkedIn™ allow users to create their own network of friends, family members, colleagues and associates. These networks may then be searched (at least to the extent that the user's information is public) to determine each contact's current and past employer information. Then, HR directors may provide lists of potential job openings to people with certain qualifications or related work experience, as provided by the person's social media profile.

In many cases, however, these job offerings are mistakenly offered by one company directly to employees at a competing company. These job offers may be unseemly, as it may appear that the company offering the job is attempting to poach employees from their competitor. Thus, at least in some cases, it may be prudent to selectively communicate job openings to potential employees who meet a predefined set of criteria.

### BRIEF SUMMARY

Embodiments described herein are directed to constructing an employee referral network, selectively communicating job opportunities to potential job referrers and to facilitating incognito job referrals. In one embodiment, a computer system imports professional contacts for an employee from at least one source of professional contacts. The computer system categorizes the imported professional contacts according to criteria provided by the employee's employer, then further constructs an employee referral network that includes the employee's professional contacts that have met the criteria provided by the employee's employer. The job opportunities are then selectively communicated through the constructed employee referral network to those professional contacts who meet the employer's criteria.

In another embodiment, a computer system receives employee information from various business entities. Each business entity includes multiple employees, and each employee has one or more professional contacts. The computer system instantiates a referral service for the business entities using the received employee information. The referral service then provides job opportunities to specified individuals according to a set of rules. The computer system selects business entities for which job opportunities are to be provided according to the set of rules and applies the set of rules to the selected to business entities to determine which individuals the job opportunities are to be sent to.

In still another embodiment, a computer system facilitates an incognito job referral. The computer system receives from a user various social contacts that are to be referred for a job without the social contacts knowing who referred them. The computer system anonymously sends job details relating to the job to the user's indicated social contacts. The computer system then monitors the job to determine who fills the job and, upon determining that the job was filled by one of the social contacts received from the user, sends a reward to the user for the referral.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1A illustrates a computer architecture in which embodiments described herein may operate including constructing an employee referral network and selectively communicating job opportunities to potential job referrers.

FIG. 1B illustrates an example embodiment where job invitations are sent to first-level professional contacts, and then on to second-level professional contacts.

FIG. 2 illustrates a flowchart of an example method for selectively communicating job opportunities to potential job referrers.

FIG. 3 illustrates an example embodiment of a referral network.

FIG. 4 illustrates an alternative example embodiment of a referral network.

FIG. 5 illustrates another alternative example embodiment of a referral network.

FIG. 6 illustrates a flowchart of an example method for constructing an employee referral network.

FIG. 7 illustrates a flowchart of an example method for selectively communicating job opportunities to potential job referrers.

FIG. 8 illustrates an embodiment in which a computer system facilitates incognito job referrals.

### DETAILED DESCRIPTION

Embodiments described herein are directed to constructing an employee referral network, selectively communicating job opportunities to potential job referrers and to facilitating incognito job referrals. In one embodiment, a computer system imports professional contacts for an employee from at least one source of professional contacts. The computer system categorizes the imported professional contacts according to criteria provided by the employee's employer, then further constructs an employee referral network that includes the employee's professional contacts that have met the criteria provided by the employee's employer. The job opportunities are then selectively communicated through the constructed employee referral network to those professional contacts who meet the employer's criteria.

In another embodiment, a computer system receives employee information from various business entities. Each business entity includes multiple employees, and each employee has one or more professional contacts. The computer system instantiates a referral service for the business entities using the received employee information. The referral service then provides job opportunities to specified individuals according to a set of rules. The computer system selects business entities for which job opportunities are to be provided according to the set of rules and applies the set of rules to the selected business entities to determine which individuals the job opportunities are to be sent to.

In still another embodiment, a computer system facilitates an incognito job referral. The computer system receives from a user various social contacts that are to be referred for a job without the social contacts knowing who referred them. The computer system anonymously sends job details relating to the job to the user's indicated social contacts. The computer system then monitors the job to determine who fills the job and, to upon determining that the job was filled by one of the social contacts received from the user, sends a reward to the user for the referral.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments described herein may comprise or utilize a special purpose or general-purpose computer including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computer system. Computer-readable media that store computer-executable instructions in the form of data are computer storage media. Computer-readable media that carry computer-executable instructions are transmission media. Thus, by way of example, and not limitation, embodiments described herein can comprise at least two distinctly different kinds of computer-readable media: computer storage media and transmission media.

Computer storage media includes RAM, ROM, EEPROM, CD-ROM, solid state drives (SSDs) that are based on RAM, Flash memory, phase-change memory (PCM), or other types of memory, or other optical disk storage, magnetic disk storage or other magnetic storage devices, or any other medium which can be used to store desired program code means in the form of computer-executable instructions, data or data structures and which can be accessed by a general purpose or special purpose computer.

A “network” is defined as one or more data links and/or data switches that enable the transport of electronic data between computer systems and/or modules and/or other electronic devices. When information is transferred or provided over a network (either hardwired, wireless, or a combination of hardwired or wireless) to a computer, the computer properly views the connection as a transmission medium. Transmission media can include a network which can be used to carry data or desired program code means in the form of computer-executable instructions or in the form of data structures and which to can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”), and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that various embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. Embodiments described herein may also be practiced in distributed system environments where local and remote computer systems that are linked (either by hardwired data links, wireless data links, or by a combination of hardwired and wireless data links) through a network, each perform tasks (e.g. cloud computing, cloud services and the like). In a distributed system environment, program modules may be located in both local and remote memory storage devices.

In this description and the following claims, “cloud computing” is defined as a model for enabling on-demand network access to a shared pool of configurable to computing resources (e.g., networks, servers, storage, applications, and services). The definition of “cloud computing” is not limited to any of the other numerous advantages that can be obtained from such a model when properly deployed.

For instance, cloud computing is currently employed in the marketplace so as to offer ubiquitous and convenient on-demand access to the shared pool of configurable computing resources. Furthermore, the shared pool of configurable computing resources can be rapidly provisioned via virtualization and released with low management effort or service provider interaction, and then scaled accordingly.

A cloud computing model can be composed of various characteristics such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth. In this description and in the claims, a “cloud computing environment” is an environment in which cloud computing is employed.

Additionally or alternatively, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), and other types of programmable hardware.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

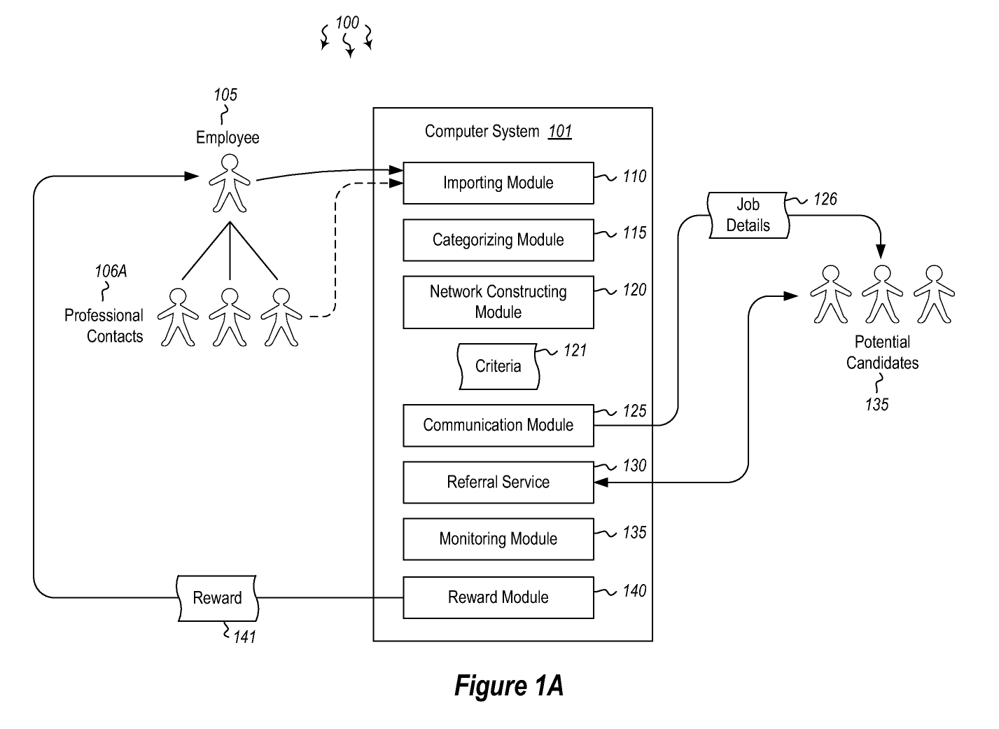

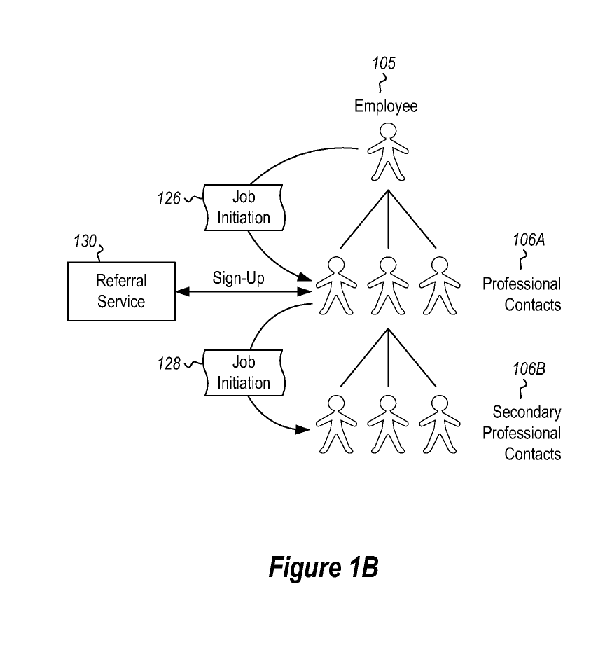

FIG. 1 illustrates a computer architecture 100 in which the principles of the present invention may be employed. Computer architecture 100 includes computer system 101. Computer system 101 may be any type of local or distributed computer system, including a cloud computing system. The computer system includes various different modules for performing a variety of different functions. For instance, computer system 101 includes an importing module 110. The importing module may be configured to import employee information from employee 105. The employee information may include personal information about the employee such as name, address, phone number, time worked for an employer, positions held by the employee and other information. The employee information may also include information about the employee's professional contacts 106A. These professional contacts may be employed by the employee's employer or by other employers.

As shown in FIG. 1B, each of the employee's professional contacts may themselves have professional contacts which, in relation to the employee 105, are a secondary level of professional contacts 106B. At least in some embodiments, however, these secondary professional contacts may not be (directly) accessible by the computer system 101. For instance, due to privacy concerns, computer system 101 may be limited to accessing only those persons that are immediate contacts of the employee 105 (i.e. professional contacts 106A). Thus, as indicated in FIG. 1B, in order for the computer system 101 to access secondary contacts, at least one of the employee's first-level professional contacts would sign up with the referral network created by the network constructing module 120 (as will be described below). Then, after signing up and providing the referral service with permission to access their contacts, the first-level professional contact 106A would be able to send job invitations to their professional contacts. These contacts are secondary professional contacts (106B) in relation to the employee 105. As such, the employee's contacts can refer their own contacts (106B) for jobs.

Each of these contacts (including substantially any number of secondary, tertiary or other contacts) may be imported and stored by importing module 110. These professional contacts may then be categorized according to one or more of a plurality of different employer-provided criteria 121. The categorization module 115 may categorize the contacts automatically, or may allow a user to categorize them manually. The criteria used by the categorization module may include any portion of employee information mentioned above, or any other type of information the employer believes is relevant. In some embodiments, the professional contacts are categorized according to current employer.

The computer system 101 also includes a network constructing module 120. The network constructing module may be configured to construct a network of categorized professional contacts for each employee. Thus, for instance, the network constructing module may build a network for employee 105 that includes one or more categorized professional contacts 106A. If any of those professional contacts joins the referral service 130, they can pass the job invitations 126 to their friends and contacts (secondary professional contacts 106B). Each of these professional contacts is categorized according to criteria 121.

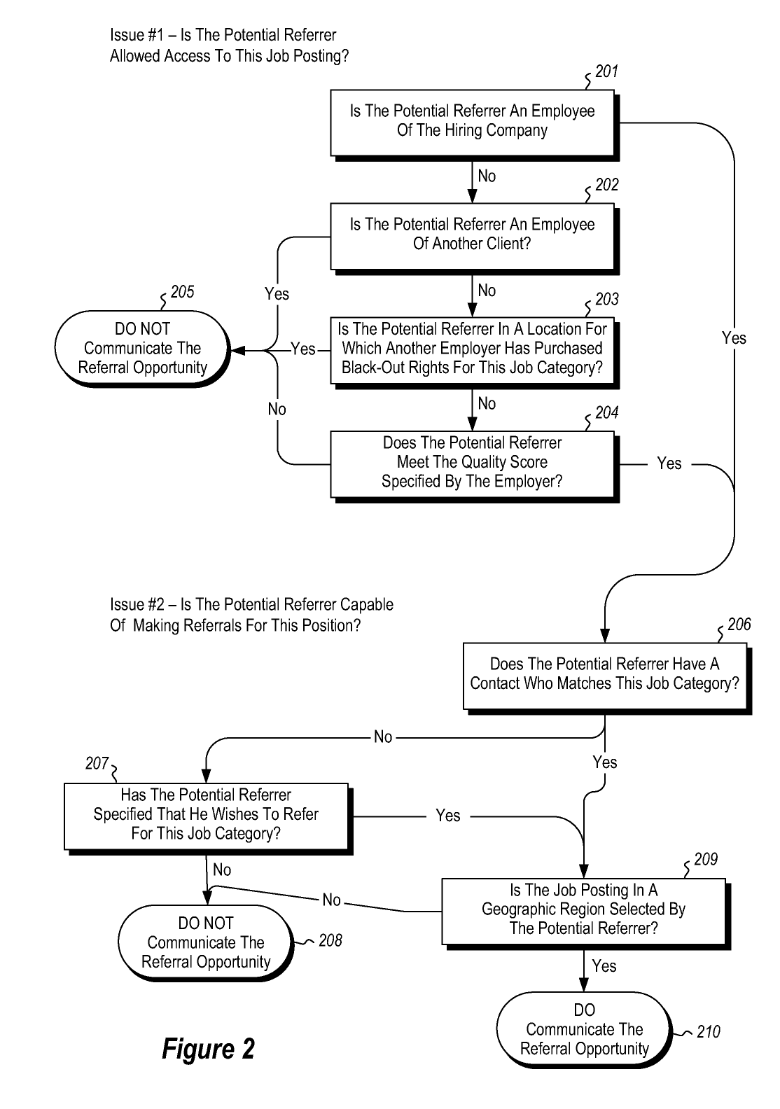

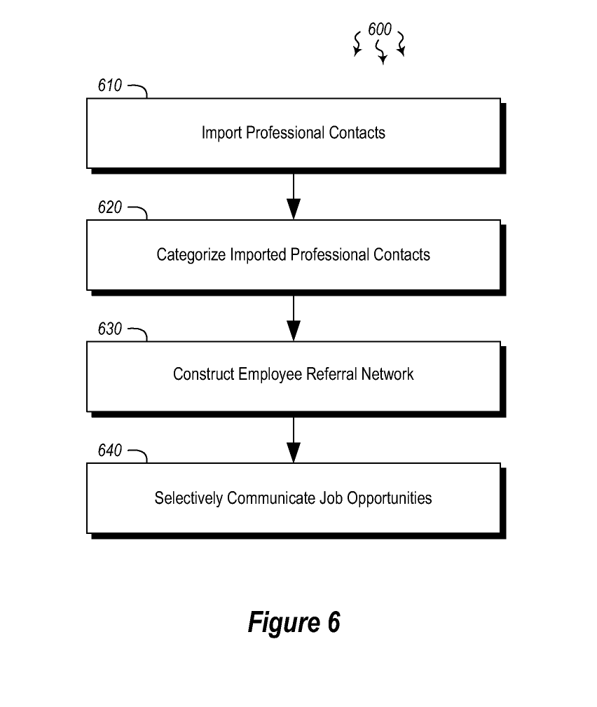

Job openings at the business or other entity where the employee 105 is currently employed may be disseminated to certain individuals or job referrers. For instance, communication module 125 may communicate a particular job opening to potential job candidates 135 for a certain job. This particular job may also be communicated to other people including job referrers (i.e. individuals that may refer another person for the open job). These job openings may be communicated to select groups of professional contacts (from among the categorized contacts) or to individuals that meet certain criteria after a specified set of rules has been applied. These rules will be described further below with regard to the flowchart and rules of FIGS. 2 and 6.

With regard to the components and data of environment 100, a computer-implemented method for constructing an employee referral network is described. The method includes importing one or more professional contacts for an employee from at least one source of professional contacts (610). For example, as outlined above, importing module 110 may import employee information describing employee 105, as well as information about the employee's professional contacts 106A. In some cases, the source of professional contacts for the employee is comprised of other employees at the employee's business. Thus, if employee 105 worked for Company A, the professional contacts that are part of group 106A would include solely employees of Company A. In other cases, the professional contacts 106A may include contacts that are employed by other companies including Company B and Company C. It will be understood that the employee's professional contacts could come from substantially any source including social networks, other professional networks, or other sources of contact information.

These imported professional contacts 106A may then be categorized according to criteria 121 provided by the employee's employer (620). For example, a job description may be parsed for certain information including keywords or phrases. The categorizing module 115 may categorize the professional contacts according to name, location, current employer, previous employer, duration of employment, qualifications such as diplomas, certifications, etc, or other criteria. This categorization may be performed automatically by computer system 101, and/or refined manually by a user of the computer system. Accordingly, once categorized, each imported professional contact will be part of at least one category within the computer system.

In some embodiments, any imported professional contacts 106A may be categorized first based on one or more keywords and secondly based on one of a plurality of specified category types. For example, a contact may be categorized based on the keyword “accounting” appearing in their resume or profile, and may be further categorized based on skills or certifications such as being a certified professional accountants (CPAs). The “accounting” keyword may also be associated with other keywords such as “audit”, “controller” or others. Thus, if a keyword is found in association with a specific professional contact, a category may be applied to limit the overall number of matches. In one specific example, the imported professional contacts may be categorized based on 1) job function (i.e. a keyword) 2) experience level (entry level, mid-level, senior, etc.) and 3) the current geographic location of the professional contact. Any associated keywords may be stored on and/or accessed through a data store. The data store may be internal to or external to computer system 101, and may include local or distributed data storage.

The importing module 110 may subsequently import secondary professional contacts 106B that are professional contacts of at least one of the employee's previously imported professional contacts 106A that has signed on to the referral service 130. Thus, the importing module 110 may look at each of the employee's professional contacts, as the employee has signed up for the referral service 130 and has given computer system 101 permission to access one or more of their contacts' information. Job invitations or details 126 may then be sent to these contacts 106A. If any of these contacts signs up for the referral service 130 (as illustrated in FIG. 1B), some or all of their contacts may be imported by importing module 110. Like the direct contacts, the secondary contacts may be categorized according to employer-provided criteria 121 manually or automatically.

The employer's criteria 121 may include a job category such as “Managerial” or “Secretarial”. As such, different employees and their professional contacts may be categorized as currently being in managerial roles, or as being qualified for managerial jobs, for example. Additionally or alternatively, the job category may include a geographic region indicating that an employee is currently living in a particular geographic region, or has indicated a desire to relocate to a particular region. As will be recognized, any of a wide variety of categories may be implemented to categorized employees and professional contacts.

In some cases, the employer's criterion excludes those professional contacts whose employers have a job opening in the same job category. Thus, if one of employee 105's professional contacts 106A worked for Company B, and employee 105 worked for Company A, Company A's criterion may exclude professional contacts from Company B that have a job opening in the same job category. Similar rules will be discussed further below. The employer's criteria may also include a quality score that indicates the determined quality of the professional contact.

Using the imported, categorized professional contacts, the network constructing module 120 of the computer system 101 may construct an employee referral network that includes the employee's professional contacts 106A that have met the criteria 121 provided by the employee's employer (630). The employee referral network thus includes those contacts that meet the criteria given by the employer. As such, when the employer changes the criteria, the employee network is updated to include or exclude contacts that now meet or no longer meet the new criteria. Job opportunities provided by employee 105's employer (e.g. Company A) may then be selectively communicated using the constructed employee referral network to those professional contacts who meet the employer's criteria (640). In this manner, an employer may selectively communicate job opportunities using the referral network to any subset of direct professional contacts 106A, based on the employer's criteria imposed by the employer.

In some embodiments, users may be prohibited from accessing professional contact sources. For example, when users are at work, they are often blocked off from social media networks, which may be sources for referrals. In such cases, computer system 101 may determine that access to at least one of the sources of professional contacts is blocked by the user's employer and prompt the employee to create a referral account with the employee referral network. The communication module 125 may receive from the employee a user name and/or a password, and may further receive a phone number for the employee (among other types of contact information). The communication module 125 may further send a communication to the employee's phone that includes a to link to a mobile browser which allows the user to provide authentication credentials to one or more sources of professional contacts (e.g. a social networking website). The link clicked by the user may initiate a transfer of data over a cellular network that, at least in some cases, is private to the user, and is not controlled by their employer.

Using the received authentication credentials, the computer system 101 may authenticate to the source(s) of professional contacts and subsequently receive from the sources of professional contacts, one or more of the employee's social contacts. The authentication credentials may be limited in duration, such that, for example, the credentials are only valid for a single authentication, or for one day. Once computer system 101 has authenticated to the user's social networks, the communication module 125 can communicate with the social networks' computer systems.

In some cases, the computer system 101 may establish a match score for one or more of the professional contacts. The match score indicates how well a professional contact is aligned with a specified job. For example, computer system 101 may parse a job description to ascertain keywords and phrases that are pertinent to that job. The keywords and phrases resulting from the parsing are compared against the employee's professional contacts 106A. If a certain contact matches multiple desired keywords, and multiple desired categories, that contact would receive a high match score. If fewer matches were found, a lower match score would be issued.

After examining a user's social contacts and determining those contact's skills and work experience, the computer system 101 may inform the user (i.e. the employee) that they have a specified number of professional contacts that have a match score beyond a specified threshold number. Thus, for example, if the user had a friend or contact that had a very high match score, the user may be notified of such. In order to maintain the contact's privacy, information identifying who the matched contact is may be omitted. The user may then choose to review their contacts to determine who the highly matched contact might be. If desired, the user may send a job invitation 126 to the determined contact. If that contact were to then join the referral service 130, the same process of parsing job details, communicating job invitations, and notifying the newly signed-up contact of potential, highly-matched contacts within their own network may be continued with the new contact. As such, both employees and their friends/contacts may make referrals for a single job.

In cases where a job invitation is sent to a first-level contact 106A, who then sends that invitation on to a contact of their own (i.e. a secondary contact 106B of the employee 105), a situation may arise in which a secondary contact fills a job based on the referral that was initially sent by the employee 105 and that was later sent by the first-level contact (as is shown in FIG. 1B). In such cases, the reward module 140 may determine a reward amount that is appropriate for each user. In some cases, the reward 141 may be split between the users 50/50, while in other cases the split may be more heavily weighted to one party or the other (e.g. 80/20, with 80% going to the initial employee). This is just one arbitrary example, and it will be understood that substantially any percentage of reward splitting between the involved parties may be implemented.

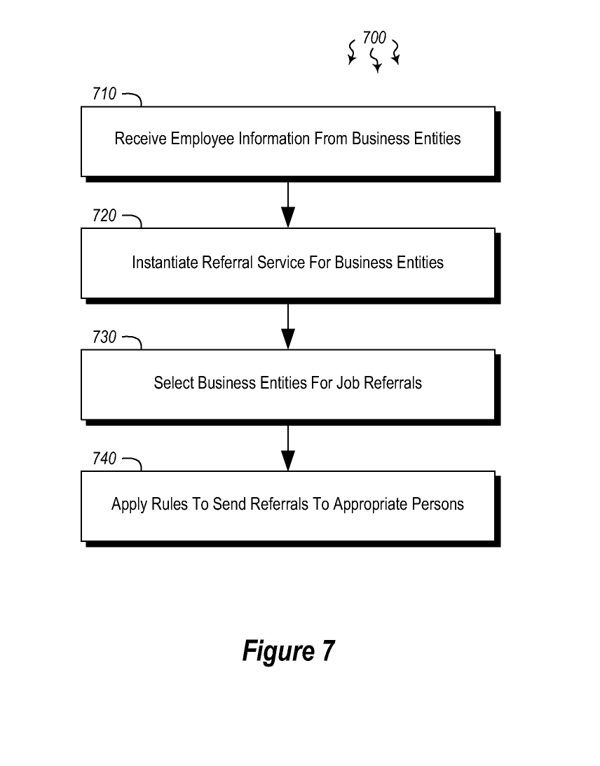

FIG. 7 describes a computer-implemented method that includes receiving employee information from one or more business entities, where each entity includes multiple different employees, and where at least one of the employees has one or more professional contacts (710). Thus, computer system 101 may receive employee information about employee 105. In different embodiments, employee 105 may have different numbers of contacts, but in this example embodiment, the employee has at least one direct professional contact 106A and at least one secondary professional contact 106B.

The computer system 101 may instantiate a referral service 130 for the one or more business entities using the received employee information (720). At least in some cases, this is substantially the same as the employee referral network established by module 120 above. The referral service provides job opportunities to specified individuals according to a set of rules or criteria. These individuals may be potential job candidates 135 or may be job referrers (i.e. people who are not interested in or are not qualified for the job, but may be able to refer someone who is available for the job). The computer system selects business entities for which job opportunities are to be provided according to the set of rules (730) and applies the set of rules to the selected business entities to determine to which individuals the job opportunities are to be sent (740).

As shown in FIG. 2, if rule 201 is answered no, one or more of rules 202, 203 and 204 is applied. Rule 201 speaks to the issue of whether a potential referrer (i.e. the individual to whom the job opening is to be sent) is allowed to access a particular job opening. Rule 201 asks if the potential referrer is an employee of the hiring company. If the answer to that question is no, then rule 202 is applied. Rule 202 asks if the potential referrer is an employee of another company that has signed on for access to job referrals through the referral service 130. If yes, then the job opportunity is not communicated to the individual. If no, then Rule 203 is applied. Rule 203 asks if the potential referrer is in a location (e.g. geographic region or other category) for which another employer has purchased black-out rights for that job category. If yes, then the job opportunity is not communicated to the individual. If no, then Rule 204 is applied. Rule 204 asks if the potential referrer meets the quality score specified by the employer. If no, then the job opportunity is not communicated to the individual, and if yes, then Rule 206 is applied.

Rule 206 speaks to a second issue of whether the potential referrer is capable of making referrals for that position. (It will be noted that if the individual is a job candidate, as opposed to a job referrer, the candidate will be able to access the job opening if the answer to Rule 201 or Rule 204 is yes). Rule 206 asks whether the potential referrer has a professional contact who matches the specified job category. If no, then Rule 207 is applied and if yes, then Rule 209 is applied. Rule 207 asks whether the potential referrer specified that he or she wishes to refer others for this job category. If no, the job opening is not sent to that potential referrer (208). If yes, Rule 209 is applied, which asks whether the job opening is in a geographic region selected by the potential referrer. If no, the job opening is not sent to that potential referrer (208). If yes, the job opening is sent to that referrer 210. Accordingly, in this manner, each job opening may be vetted based on the rules put in place by the employer.

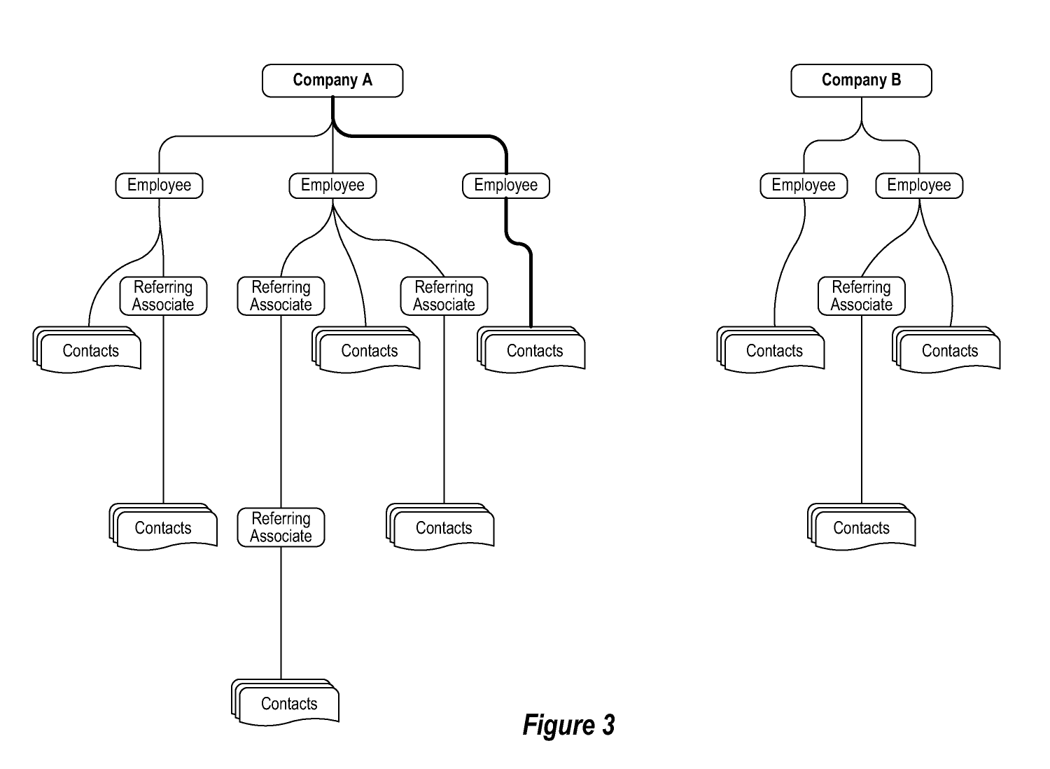

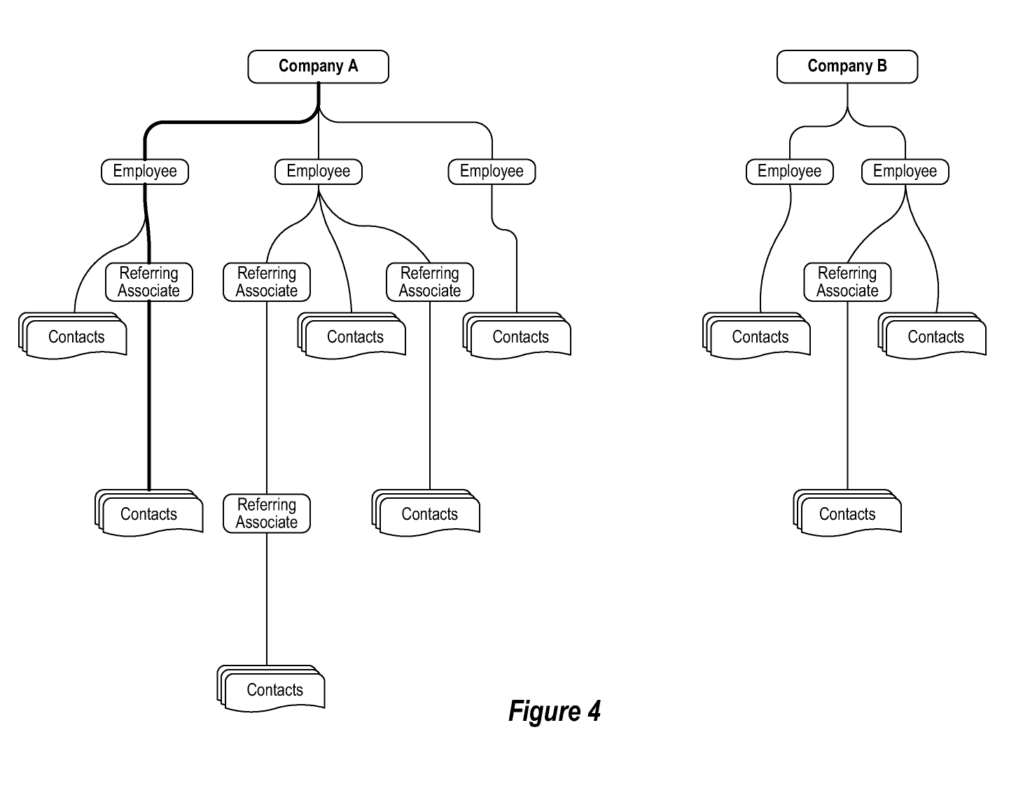

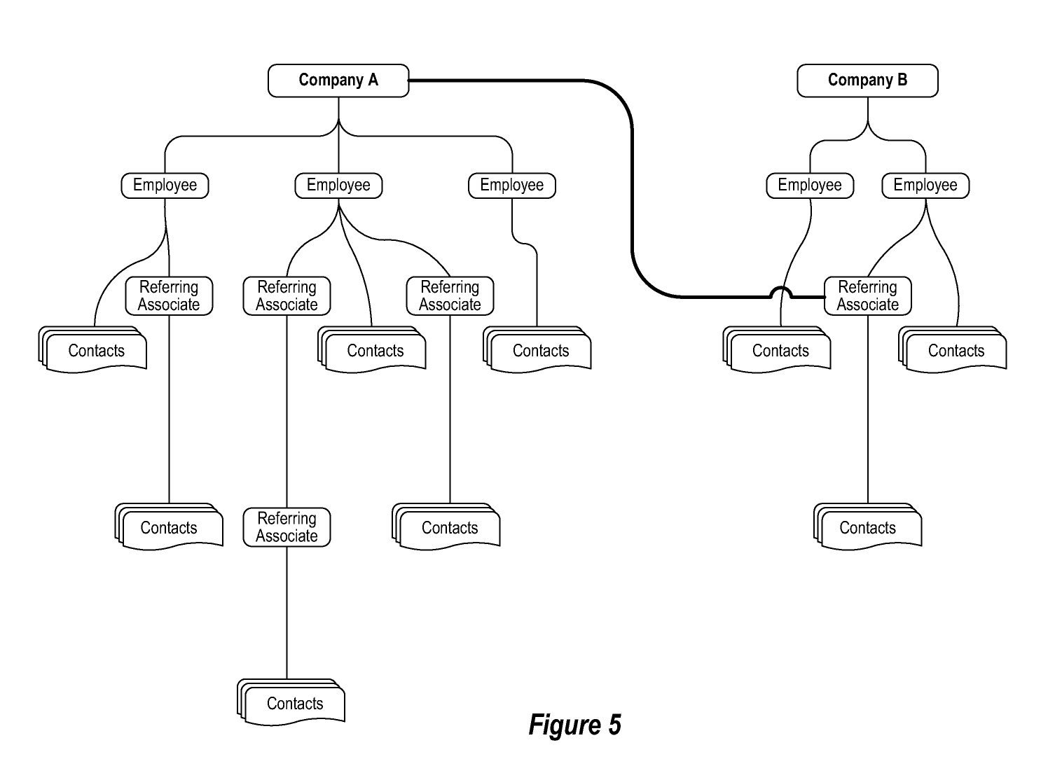

These rules may be applied across different levels of professional contacts, and potentially among other individuals such as referring associates. Referring associates may be individuals or entities that help place candidates with potential employers. Thus, as shown in FIG. 3, Company A and Company B may both be members of referral service 130 (from FIG. 1). Both companies may have multiple different employees, each with different contacts (and, in some cases, referring associates). FIG. 3 illustrates a scenario where one of Company A's employee's professional contacts fills a job opening referred by an employee of Company A (as indicated by the thicker, darker line between the Company A employee and the employee's contact). FIG. 4 illustrates a scenario where one of Company A's employee's referring associate's contacts fills a job opening referred by a referring associate of one of Company A's employees (as indicated by the thicker, darker line between the Company A employee and the referring associate's contact. FIG. 5 illustrates a scenario where one of Company B's employee's referring associate's contacts fills the job opening of Company A (as indicated by the thicker, darker line between Company A and Company B's employee's referring associate.

As will be understood, the scenarios of FIGS. 3-5 illustrate just a few of the to many different possible job referring scenarios. Using the professional contacts imported from employees, a company can build an employee referral network. Using this network (e.g. referral service 130), a company or other entity may selectively communicate job referrals to desired individuals. These individuals may be members of certain categories, as categorized by the computer system 101. Moreover, these individuals may be those that have passed a series of configurable rules. These rules ensure that only those individuals desired by the company posting the job opening receive the opening.

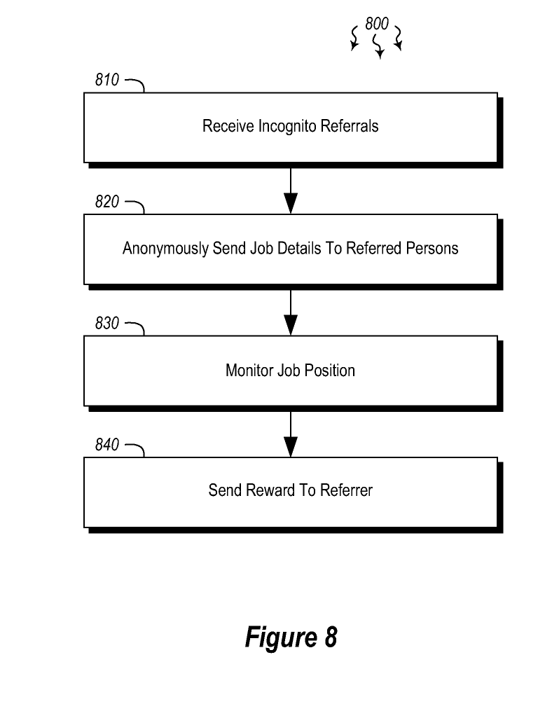

As shown in FIG. 8, a flowchart is provided which illustrates an embodiment in which an incognito referral is facilitated. An incognito referral, as the term is used herein, refers to a referral given by a user in which the referring user wishes to remain anonymous. Accordingly, the communication module 125 may receive from a user (e.g. 105) an indication of one or more social contacts 106A that are to be referred for a job without the social contacts knowing who referred them (810). The computer system 101 may anonymously send job details 126 relating to the job to the indicated social contacts (820). These job details are sent at the behest of the user, while keeping the user's identity hidden from the contacts. The monitoring module 135 of computer system 101 may then monitor the job to determine who eventually fills the job (830) and, upon determining that the job was filled by one of the social contacts received from the user, the reward module 140 may send a reward 141 to the user 105 for the referral.

It will be appreciated that the use of the term “contact” herein includes various types of contacts. For example, contacts may include professional, social, or other contacts. Furthermore the use of the term contact with any modifier may be interchangeable with any other type of contact unless otherwise indicated. For instance, where the term professional contact is used, social contact may also be acceptable or vice versa. These terms are merely illustrative in their various contexts.

Accordingly, methods, systems and computer program products are provided which gather employee and professional contact data to construct an employee referral network. Moreover, methods, systems and computer program products are provided which use such an employee referral network to selectively communicate job opportunities to potential job referrers or other individuals such as potential job candidates.

The present invention may be embodied in other specific forms without departing from its spirit or essential characteristics. The described embodiments are to be considered in all respects only as illustrative and not restrictive. The scope of the to invention is, therefore, indicated by the appended claims rather than by the foregoing description. All changes which come within the meaning and range of equivalency of the claims are to be embraced within their scope.

1. A computer system comprising the following:
one or more processors;
system memory;
one or more computer-readable storage media having stored thereon computer-executable instructions that, when executed by the one or more processors, causes the computing system to perform a method for constructing an employee referral network, the method comprising the following:
importing one or more professional contacts for an employee from at least one source of professional contacts;
categorizing the imported professional contacts according to one or more criteria provided by the employee's employer;
constructing an employee referral network that includes the employee's professional contacts that have met the criteria provided by the employee's employer; and
selectively communicating one or more job opportunities through the constructed employee referral network to those professional contacts who meet the employer's criteria.

2. The computer system of claim 1, further comprising:
importing one or more secondary professional contacts that are professional contacts of the employee's previously imported professional contacts; and
categorizing the secondary imported professional contacts according to the criteria provided by the employee's employer;

3. The computer system of claim 1, wherein the employer's criteria comprises at least one of a job category and a geographic region.

3. (canceled)

4. The computer system of claim 1, wherein the employer's criteria comprises a quality score that indicates the determined quality of the professional contact.

5. The computer system of claim 1, wherein the source of professional contacts for the employee comprises other employees at the employee's business.

6. The computer system of claim 1, wherein each imported professional contact is automatically categorized according to one or more criteria provided by the employee's employer.

7. The computer system of claim 2, wherein the job opportunities are selectively communicated through the constructed employee referral network to those secondary professional contacts who meet the employer's criteria.

8. The computer system of claim 2, wherein the imported professional contacts and secondary contacts are categorized first based on one or more keywords and secondly based on one of a plurality of specified category types.

9. The computer system of claim 8, further comprising accessing one or more related keywords to perform the categorization of professional contacts.

10. The computer system of claim 2, wherein the imported professional contacts and secondary contacts are categorized based on 1) job function 2) experience level and 3) current geographic location of the professional contact.

11. The computer system of claim 1, further comprising:
determining that access to at least one of the sources of professional contacts is blocked by the employer;
prompting the employee to create a referral account with the employee referral network;
receiving from the employee at least one of a user name and a password, and further receiving a phone number for the employee;
sending a communication to the employee's phone that includes a link to a mobile browser which allows the user to provide authentication credentials to one or more sources of professional contacts;
authenticating to the one or more sources of professional contacts using the received authentication credentials; and
receiving, from the sources of professional contacts, one or more of the employee's social contacts.

12. The computer system of claim of claim 1, further comprising:
establishing a match score for one or more of the professional contacts, the match score indicating how well a contact is aligned with a specified job; and
informing the employee that they have a specified number of professional contacts that have a match score beyond a specified threshold number.

13. The computer system of claim 12, wherein informing the employee of the matched contacts omits information identifying who the matched contacts are.

14. A computer system comprising the following:
one or more processors;
system memory;
one or more computer-readable storage media having stored thereon computer-executable instructions that, when executed by the one or more processors, causes the computing system to perform a method for selectively communicating job opportunities to potential job referrers, the method comprising the following:
receiving employee information from one or more business entities, each entity comprising a plurality of employees, wherein at least one of the employees has one or more professional contacts;
instantiating a referral service for the business entities using the received employee information, wherein the referral service provides job opportunities to specified individuals according to a set of rules;
selecting one or more business entities for which job opportunities are to be provided according to the set of rules; and
applying the set of rules to the selected business entities to determine which individuals the job opportunities are to be sent to.

15. The computer system of claim 14, wherein the set of rules includes at least one rule that queries whether the individual is an employee of the hiring company and, if not, preventing the job opportunities from being sent to the determined individual.

16. The computer system of claim 14, wherein the set of rules includes at least one rule that queries whether the individual is an employee of another business entity that also uses the referral service and, if so, preventing the job opportunities from being sent to the determined individual.

17. The computer system of claim 14, wherein the set of rules includes at least one rule that queries whether the individual is in a location for which another business entity has purchased black-out rights and, if so, preventing the job opportunities from being sent to the determined individual.

18. The computer system of claim 14, wherein the set of rules includes at least one rule that queries whether the individual has contacts in a specified job category and whether the individual has indicated a desire to receive job opportunities and, if so, sending the job opportunities to the determined individual.

19. A computer system comprising the following:
one or more processors;
system memory;
one or more computer-readable storage media having stored thereon computer-executable instructions that, when executed by the one or more processors, causes the computing system to perform a method for facilitating an incognito job referral, the method comprising the following:
receiving from a user an indication of one or more social contacts that are to be referred for a job without the social contacts knowing who referred them;
anonymously sending job details relating to the job to the one or more indicated social contacts;
monitoring the job to determine who fills the job; and
upon determining that the job was filled by one of the social contacts received from the user, sending a reward to the user for the referral.

20. (canceled)

21. The computer system of claim 3, wherein the employer's criterion excludes those professional contacts whose employers have a job opening in the same job category.
